(19) United States
(12) Patent Application Publication
(10) Pub. No.: US 2024/0019773 A1
(43) Pub. Date: Jan. 18, 2024

(54) Projector assembly and projection system

(71) Applicant: PLASTIC OMNIUM LIGHTING SYSTEMS GMBH, Munich (DE)

(72) Inventors: Sergey KHRUSHCHEV, Regensburg (DE); Andreas HARTMANN, Ulm (DE); Thomas FEIL, Iggingen ALLEMAGNE (DE); Eugen PAPPELHEIM, Heidenheim (DE)

(73) Assignee: PLASTIC OMNIUM LIGHTING SYSTEMS GMBH, Munich (DE)

(21) Appl. No.: 18/222,751

(22) Filed: Jul. 17, 2023

(30) Foreign Application Priority Data
Jul. 18, 2022 (DE) 102022117917.6

(51) Int. Cl. G03B 21/10; G03B 21/20

(52) U.S. Cl. CPC G03B 21/10; G03B 21/208

(57) ABSTRACT

A projector assembly with at least one light source, which is connected downstream of a gobo screen, is disclosed. The gobo screen has a gobo aperture diaphragm and a gobo lens. A projection lens is connected downstream of the gobo screen. In addition, an aperture diaphragm is connected downstream of the gobo screen. The light emitted by the light source is focused in the aperture diaphragm via the gobo lens. The image from the gobo screen is displayed in the far field via the projection lens.

### CROSS-REFERENCE TO RELATED APPLICATIONS

This application claims the priority to DE application Serial No. 102022117917.6, filed Jul. 18, 2022, the disclosure of which is hereby incorporated in its entirety by reference herein.

### TECHNICAL FIELD

The invention is based on a projector assembly, in particular for a vehicle, with which a light image is displayed in a far field. In addition, the invention relates to a projection system with this type of projector assembly.

### BACKGROUND

Using projector assemblies in a vehicle, for example a passenger car, is known from the prior art. These serve, for example, to display a vehicle logo on an imaging surface, for example a road surface, next to the vehicle. Such a projector assembly has, for example, a light source in the form of an LED (light emitting diode), which is connected downstream of a gobo screen with a logo. The gobo screen in turn is connected downstream of one or more lenses to display the logo on the gobo screen in the far field.

### SUMMARY

The object of the present invention is to provide a projector assembly and a projection system for displaying information, in particular a logo, which displays in high quality and/or to provide a comparatively large focal length in a cost-effective and/or simple manner in terms of apparatus and/or with little installation space.

The object with regard to the projector assembly is solved according to the features of claim 1 and with respect to the projection system according to the features of claim 10.

Particularly advantageous embodiments are found in the dependent claims.

According to the invention, a projector assembly with at least one light source is provided, via which light can be emitted. In addition, the projector assembly has at least one gobo that is connected downstream of the light source, i.e. is arranged in the beam path of the emitted light. The gobo screen preferably contains information, in particular a logo, which can be displayed via the projector assembly. Further preferably, a gobo aperture diaphragm is arranged upstream or downstream or is assigned to the gobo screen. Alternatively, it is conceivable that the gobo screen has a gobo aperture diaphragm. In addition, a gobo lens is provided, which is connected upstream or downstream of the gobo screen. If the gobo lens is connected upstream of the gobo screen, the gobo lens is preferably arranged between the light source and the gobo screen. A projection lens is provided as a further lens, which is in turn arranged downstream of the gobo screen, that is to say is arranged downstream of the gobo screen in the beam path. In addition, an aperture diaphragm is arranged, which is likewise connected downstream of the gobo screen. As seen in the beam path, the aperture diaphragm for the projection lens can be, for example, arranged upstream or downstream of the projection lens. Preferably, the gobo lens is configured and arranged in such a way that the light emitted by the light source, in particular via the gobo, is focused into the image plane of the aperture diaphragm. Furthermore, the projection lens is preferably designed and arranged in such a way that it displays the image plane from the gobo screen in the far field.

The projector assembly according to the invention is based on so-called “Köhler Illumination”. Köhler improved the lighting system of microscopes with his system. Köhler developed an optical system in order to enable a homogeneous illumination of a microscope stage. This system has a tungsten lamp, a collector lens and a condenser lens. The collector lens bundles the light from the tungsten lamp and projects an image of a coil from the tungsten lamp onto an aperture diaphragm upstream of the condenser lens. The condenser lens, in turn, projects the image plane of a further aperture diaphragm downstream of and assigned to the collector lens onto the microscope stage. In the projector assembly according to the invention, based on the Köhler principle, the image plane of the gobo, which contains a logo, for example, is imaged in the far field, with it being shown that this results in a high image quality with little outlay in terms of apparatus due to the embodiment according to the invention. Moreover, it has been shown that opto-mechanical tolerances for the components of the projector assembly can be comparatively large and nevertheless a comparatively high imaging quality is made possible, which overall leads to a robust product design. Furthermore, it has been shown that, with the projector assembly, a comparatively large gobo screen or a comparatively large logo is made possible in a simple manner in the case of a comparatively high imaging quality. Due to the comparatively large gobo screen, an energy density resulting from the light that acts on the gobo screen is lower compared to the prior art. As a result of the possibility of making the gobo screen larger, a higher flexibility also results for different gobo or logo sizes. Furthermore, the projector assembly advantageously leads to a reduction of a chromatic aberration without a diffractive optical element, such as a hybrid asphere, having to be used. In addition, the projector assembly according to the invention allows a focal length for the same image or gobo size to be increased compared to the prior art, whereby tolerances for positioning the projection lens are increased. In addition, a large selection of projection lenses for different image sizes can be used. Image sizes can be provided, for example, between 350 to 1,400 mm in the far field at a projection distance of 1 m, wherein the projection lenses have low or moderate chromatic aberrations.

In a further embodiment of the invention, the gobo lens has a convex light entry surface and a planar light exit surface. For example, the gobo lens is designed as a plano-convex lens. With the gobo lens, the light can thus be focused in a simple manner.

In a further embodiment of the invention, a collimation lens can additionally be provided, which is connected upstream of the gobo lens and the gobo screen and the gobo aperture diaphragm and downstream of the light source. With the collimation lens, the radiation of the light source can be collimated in a simple manner in terms of device technology, which leads to an improvement in the imaging quality and supports the focusing of the gobo lens. Preferably, the collimation lens collimates the light in a light cone or light cone frustum, which tapers in the direction of radiation and whose lateral surface is inclined with respect to the main emission axis by 10° or by approximately 10°. The projector assembly according to the invention advantageously allows a distance between the collimation lens and the light source to be comparatively large. As a result, a cost-effective material, such as plastic, can be used for the collimation lens and/or for one or more of the further lenses instead of, for example, comparatively cost-intensive silicone.

Preferably, the collimation lens and/or the gobo lens and/or the projection lens are arranged one behind the other in the beam path of the light emitted by the light source. These are further preferably located on a main emission axis and can be arranged coaxially to one another. It is also conceivable that one or more or all lenses is/are rotationally symmetrical. In addition, the aperture diaphragm and gobo aperture diaphragm can have a circular opening cross section and/or lie on the main emission axis and/or be arranged coaxially to one or more lenses.

The gobo screen is preferably a simple gobo (gobo=graphic optical blackout). The gobo screen can have, for example, a, in particular transparent, carrier with a light entry and a light exit surface. Further preferably, the gobo device is easily formed or arranged on the light exit surface. The gobo can be designed particularly easily as a film. This is, for example, simply printed and can thereby have light-permeable film sections and light-impermeable and/or light-partially permeable film sections in order to form information, such as a logo. The gobo in the form of the film can be easily applied to the light entry surface and/or to the light exit surface of the carrier in terms of device technology. It is also conceivable, for example, to apply a film onto the light entry surface and a film onto the light exit surface of the carrier. The carrier can be designed, for example, as a carrier disk or the gobo lens is simply provided as a carrier. Alternatively or additionally, provision can be made for the gobo to be colored or for the film to be printed in color in order to form the gobo. The light entry surface and the light exit surface of the carrier can be arranged, for example, at a parallel distance from one another. Preferably, the gobo is in a plane, whereby it can be easily displayed. In other words, the projection lens can display the gobo, which is flat or applied to a flat surface of the gobo lens or the carrier, in the far field. By using the gobo as a film, it is conceivable, as already mentioned, to print and/or scale this, wherein one or more colors or different colors can be used. In this way, a colored image can be formed. By using the film, a cost-intensive glass gobo disk, as is frequently used in the prior art, is no longer necessary. As already mentioned above, due to the projector assembly the gobo screen can be comparatively large and thus the gobo can also be comparatively large. This further leads to the advantage that, for example, color printers with a lower resolution, which are more cost-effective and nevertheless lead to a gobo that has a high image quality in the far field, can be used. The gobo has, for example, a size or a maximum diameter between 2 and 5 mm, wherein the size in the gobo plane is measured.

The gobo screen preferably contains information to be displayed via the projector assembly, such as a logo or a symbol or a character or an image.

In a further embodiment of the invention, the gobo aperture diaphragm is connected upstream of the carrier and/or the gobo, in particular, directly connected. It is also conceivable to connect the gobo aperture diaphragm directly to the carrier and/or the gobo. Furthermore, it is conceivable that the gobo aperture diaphragm surrounds the projection lens, in particular, completely surrounds. The gobo aperture diaphragm can, for example, extend in a plane in which an edge of the light entry surface of the projection lens can lie. The gobo aperture diaphragm is arranged, for example, at a parallel distance or parallel to the gobo.

The arrangement of the gobo lens at or adjacent to the gobo position is extremely advantageous for high imaging quality. Due to the convex-planar configuration of the gobo lens, the gobo can be arranged as close as possible to or onto the planar or planar surface or light exit surface of the gobo lens.

Preferably, at least one or more light-emitting diodes (LEDs) are provided as the light source, which are preferably designed as surface emitters with homogeneous spatial light distribution.

In a further embodiment of the invention, the aperture diaphragm downstream of the gobo screen is arranged downstream of the projection lens. In contrast, the aperture diaphragm in front of the projection lens is usually provided in the case of the classic Köhler illumination. The position of the aperture diaphragm defines the length of the projector assembly. By positioning this behind the projection lens, a greater length of the projector assembly and/or of the projection lens is made possible. It would also be conceivable to form or arrange the aperture diaphragm arranged downstream of the gobo screen on the light exit surface of the projection lens or at the end of the projection lens. Alternatively, the aperture diaphragm can be spaced apart from the projection lens. It is conceivable here to form the aperture diaphragm on or in a window that is connected downstream of the projection lens and forms, for example, a light exit window or end window of the projector assembly. The aperture diaphragm has a light passage that is comprised of a light-impermeable and/or light-absorbing material, for example metal. The aperture diaphragm is preferably a mechanical diaphragm that reduces a diameter of the beam path for the light or of the beam of rays from the light. It can thus serve as a correction parameter for the objective diameter of the projection lens and for the image quality. In other words, the aperture diaphragm is arranged on the rear side of the projection line.

The projection lens is, for example, cylindrical or circular cylindrical and/or can have a convex light entry surface and/or a convex light exit surface. The projection lens and the projector assembly can be designed in such a way that light entering via the or a light entry surface of the projection lens is spaced apart from a circumference of the light entry surface. In other words, light only enters in the inner region of the light entry surface or the projection lens. By using the projector assembly or Köhler illumination, the image quality is improved as a result, since only the inner part of the projection lens is inserted and illuminated. This allows better imaging quality in combination with a smaller lens size and a robust optically mechanical design.

The collimation lens is, for example, cylindrical or circular cylindrical and has a convex light entry surface and/or a convex light exit surface.

Advantageously, the projection lens has a frustoconical lateral surface starting from its light exit surface or is configured in the shape of a truncated cone. The frustoconical lateral surface is distributed in the direction towards the light source or counter to the radiation direction. As a result of the frustoconical lateral surface, the light exit surface forms the aperture diaphragm. In a further embodiment, the lateral surface can extend up to the light entry surface of the projection lens or the lateral surface extends up to a radial mounting collar for the projection lens. This can be formed between the light entry surface and the lateral surface of the projection lens. The mounting collar, in turn, can extend from the light entry surface, viewed in the direction of the main emission axis. The aperture diaphragm is formed on or in the light exit surface of the rear side of the projection lens or through the light exit surface. A physical aperture diaphragm, which consists, for example, of metal or light-absorbing material, can be conserved by the truncated cone-shaped lateral surface or by the frustoconical section of the projection lens formed thereby, which is delimited at the end by the light exit surface. In other words, due to the special beam pattern in the interior of the projection lens, the aperture diaphragm is realized as a conical surface, which tapers from the clear optical diaphragm from the front surface of the projection lens to the rear surface of the projection lens.

In a further embodiment of the invention, a housing is provided in which the collimation lens and/or the projection lens and/or the carrier and/or the gobo lens are arranged and attached or fixed. With the components arranged therein, the housing preferably forms a module. Preferably, all the lenses and/or the carriers are provided and fixed in the housing. In turn, the housing can, for example, be arranged or integrated into a further housing or lamp housing or projector housing, in particular inside. Preferably, the housing has a housing inlet and a housing outlet opening for the light. It is thus possible that the light source can also be arranged outside the housing or can be coupled directly into the housing inlet opening and light via the housing inlet opening. Of course, it is conceivable that the light source is also provided within the housing. It would also be conceivable for no housing inlet opening to be formed.

The housing advantageously has a gobo contact surface for the gobo. This can surround the beam path of the beams at least in sections or completely. The housing and the carrier and/or the gobo lens are designed in such a way that the carrier and/or the gobo lens can be fastened at different positions onto the gobo contact surface. As a result, the carrier and/or the gobo lens can be displaced and positioned within a certain region before the final fixing in the housing, in order to position and orient them relative to the collimation lens and/or to the projection lens. In other words, a clearance suitable for the carrier and/or for the gobo lens in the transverse direction to the beam path or in the transverse direction to the main emission axis is formed in the housing. In other words, the gobo contact surface, the carrier and/or the gobo lens and the housing are designed in such a way that the carrier and/or the gobo lens can be displaced relative, in particular transversely, to the main emission axis on the gobo contact surface before fastening.

Preferably, one or more adhesive region(s) or adhesive point(s) is/are provided between the gobo contact surface and the carrier or the gobo lens in order to bond them to one another. The adhesive for the adhesive region (s) is preferably UV-curable. It is conceivable that, after arranging the carrier or the gobo lens on the gobo contact surface, adhesive regions with adhesive are provided and the carrier or gobo lens is then initially positioned, wherein this/these is/are displaceable on the gobo contact surface. After positioning, the adhesive is UV-cured, whereby the relative position of the carrier or of the gobo lens is fixed onto the gobo contact surface.

The gobo aperture diaphragm is preferably formed by the housing, which is simple and cost-effective in terms of device technology. For example, the gobo aperture diaphragm is formed by an inner radial collar on the housing, which has an inner, in particular circular cylindrical or cylindrical or frustoconical lateral surface, which surrounds the beam path. An end face of the radial collar pointing in the radiation direction can form the gobo contact surface in a simple way in terms of device technology. The gobo contact surface can point in the radiation direction and/or lie in a plane that extends transversely to the main emission direction.

The housing is preferably designed to be space-saving and simple in terms of device technology in an approximately tubular manner.

In a further embodiment of the invention, the housing has an inner step. This can have a stepped surface pointing counter to the direction of radiation, on which the collimation lens is supported axially, in particular via a radial collar formed on the collimation lens. As seen in the direction of radiation, the stepped surface is formed in front of the gobo contact surface and/or in front of the inner radial collar. The inner step can have a first inner, in particular circular cylindrical or cylindrical or frustoconical, stepped lateral surface. This can form a housing inlet opening or can be open towards the housing inlet opening and extend up to the stepped surface. In addition, the inner step can have a second inner, in particular circular cylindrical or cylindrical or frustoconical, stepped lateral surface. This can extend from the stepped surface as seen in the direction of radiation and have a smaller diameter compared to the first stepped surface. The stepped lateral surfaces are preferably arranged coaxially to one another. The collimation lens can be radially supported on the inner first stepped lateral surface, in particular via its radial collar. The stepped lateral surface(s) is/are truncated cone-shaped and taper(s) preferably in the radiation direction.

Furthermore, provision can be made that at least one housing spring, in particular in one piece with the housing, is formed in the region of the first inner stepped lateral surface of the step. In the mounted state of the collimation lens, in particular via the radial collar of the collimation lens, this can apply a spring force to the collimation lens on its side facing the housing opening. As a result, the collimation lens between the stepped surface and the housing spring can be held or tensioned in a simple manner. Preferably, a plurality of housing springs, in particular on a pitch circle, are designed to apply a spring force uniformly to the collimation lens.

The gobo lens is advantageously arranged in the region of the second inner stepped lateral surface of the inner step. The gobo lens can be supported on one or the radial collar of the housing, which is preferably adjacent to the second inner stepped lateral surface in the radiation direction.

At least one housing spring can be formed in the region of the second inner stepped lateral surface, in particular in one piece in the housing. In the mounted state of the gobo lens, this can apply a spring force to the gobo lens on its side facing the housing opening. The gobo lens can thus be easily tensioned between the radial collar of the housing and the housing spring. It would be conceivable to provide a plurality of housing springs, which are preferably arranged on a pitch circle in order to apply force to the gobo lens uniformly.

In a further embodiment of the invention, the housing has an inner step which has a stepped surface pointing in the direction of radiation, on which the projection lens can be axially supported, in particular via a radial collar formed on the projection lens. As seen in the direction of radiation, the stepped surface can be formed after the gobo contact surface and/or after the inner radial collar of the housing with the gobo contact surface. The projection lens can be easily arranged and mounted in the housing via the inner step. The inner step can have a first inner, in particular circular cylindrical or cylindrical or frustoconical, stepped lateral surface, which forms a housing outlet opening or is open towards the housing outlet opening. If the inner stepped lateral surface has a truncated cone shape, it preferably widens in the radiation direction. The projection lens can easily be inserted into the housing via the first inner stepped lateral surface. The first inner stepped lateral surface preferably extends up to the stepped surface. In the step, a second inner, in particular cylindrical or circular cylindrical or frustoconical, stepped lateral surface can be provided, which extends from the stepped surface counter to the radiation direction and has a smaller diameter compared to the first stepped lateral surface. The stepped lateral surfaces are preferably arranged coaxially to one another. If the second inner stepped lateral surface has a truncated cone shape, it preferably widens in the radiation direction. The carrier and/or the gobo lens can be radially supported on the second inner stepped lateral surface. Preferably, the carrier and/or the gobo lens is mounted into the housing via the inner step. The projection lens can be radially supported on the inner first stepped lateral surface, in particular via its radial collar.

In the region of the first inner stepped lateral surface, at least one housing spring is formed, in particular integrally, with the housing. In the mounted state of the projection lens, this can apply a spring force to the projection lens, in particular to the radial collar of the projection lens, on its side facing the housing outlet opening. As a result, the projection lens can easily be tensioned between the stepped surface and the housing spring.

If two inner steps are provided, the lenses can be mounted in a simple manner from different sides, which enables rapid assembly. This can be made possible in particular without tools due to the housing springs.

Advantageously, the housing spring or a respective housing spring projects in a ramp-like manner from a spring space formed in the housing and opened to the respective stepped lateral surface in the lens space tensioned by the respective stepped lateral surface and has a ramp surface. This can extend inward and in the mounting direction when viewed in the mounting direction of the corresponding lens. When the corresponding lens is mounted, when it is inserted axially or along the optical main axis into the housing, it can press the housing spring elastically into the spring space over the ramp surface. After a predetermined mounting path, the corresponding lens leaves the ramp surface, as a result of which the housing spring is relaxed back into the lens space and projects therein and, in this case, overlaps the lens, in particular with a spring contact surface. The housing spring can be configured in such a way that, when the corresponding lens is overlapped, the latter is acted upon with a spring force, in particular via the spring contact surface.

According to the invention, a projection system comprising the projector assembly is provided according to one or more of the aspects set forth above and below. The projection system has a system housing into which the projector assembly, which preferably has a housing, is inserted and/or integrated. The projection system can have further functional components. The projector assembly can thus be easily mounted as a “component” or module in the system housing.

The applicant reserves the right to make an independent claim in respect of a vehicle that has the projection system and/or the projector assembly according to one or more of the aforementioned aspects. The vehicle may be a utility vehicle or a water-bound vehicle or a land-bound vehicle. The land-bound vehicle can be a motor vehicle or a rail vehicle or a bicycle. The vehicle is particularly preferably a truck or a passenger car or a motorcycle. The vehicle can also be designed as a non-autonomous or partially autonomous or autonomous vehicle.

### BRIEF DESCRIPTION OF THE DRAWINGS

The invention will be explained in more detail below with reference to exemplary embodiments. In the figures:

FIG. 1a schematically shows a side view of a projector assembly according to a first embodiment,

FIG. 1b schematically shows, in a side view, the projector assembly from FIG. 1a, wherein beam light projected by the projector assembly is shown schematically,

FIGS. 2 to 7 each schematically show a side view of a projector assembly according to a respective exemplary embodiment,

FIG. 8a is a perspective view of a projector assembly according to a further embodiment, together with a housing,

FIG. 8b is a longitudinal section through the projector assembly shown in FIG. 8a,

FIG. 8c is a semi-transparent representation of a section of the projector assembly from FIG. 8a, and

FIG. 9 is a perspective view of a projection system with the projector assembly shown in FIGS. 8a to 8c.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

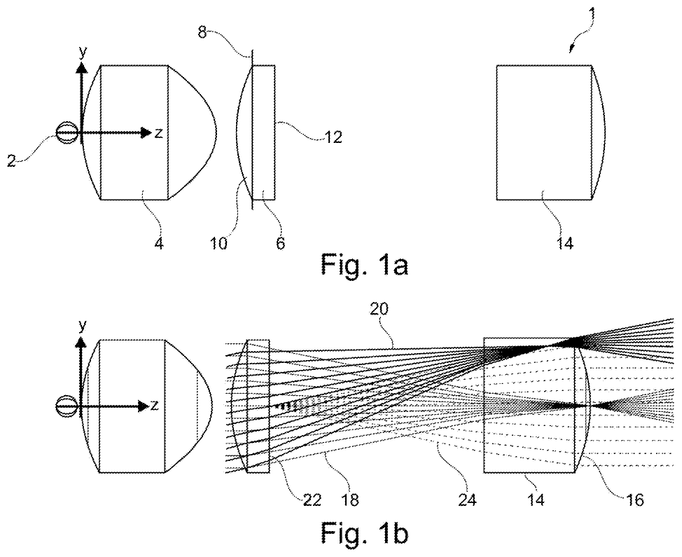

According to FIG. 1a, optical components of a projector assembly 1 according to a first embodiment are shown. This has a light source 2 in the form of an LED. A collimation lens 4 is arranged in the beam path downstream of the light source 2. In turn, a gobo lens 6 is provided. This is surrounded by a gobo aperture diaphragm 8. The gobo lens 6 has a convex light entry surface 10 and a planar light exit surface 12. The light entry surface 10 has an edge that lies in a plane with the gobo aperture diaphragm 8 and/or an image plane from the gobo aperture diaphragm 8. Between the light entry surface 10 and the light exit surface 12, the gobo lens 6 is of circular cylindrical design. A projection lens 14 is arranged downstream of the gobo lens 6. The lenses 4, 6 and 14 are arranged coaxially to one another and, with their respective longitudinal axis, preferably lie on the main emission axis of the light source 2 or at the parallel distance from the main emission axis.

The collimation lens 4 collimates the light emitted by the light source 2 in a light cone, which tapers in the beam direction. According to FIG. 1b, the gobo lens 6 focuses the light emitted by the light source 2 into an aperture diaphragm for the projection lens 14, which is formed by the light exit surface 16 from the projection lens 14, based on “Köhler Illumination”. The light is shown by way of example with two beam bundles 18 and 20. The projection lens 14 is designed in such a way that, according to FIG. 1b, it displays a gobo screen in the form of a gobo 22 (gobo=graphitic optical black out) in a far field. The gobo 22 is applied to the planar light exit surface 12 of the gobo lens 6. The projection via the projection lens 14 is shown schematically in FIG. 1b with the beam 24. The gobo aperture diaphragm 8 from FIG. 1a is a mechanically formed diaphragm that reduces a diameter of the radiation beams, which forms a correction parameter for the lens diameter and improves imaging quality.

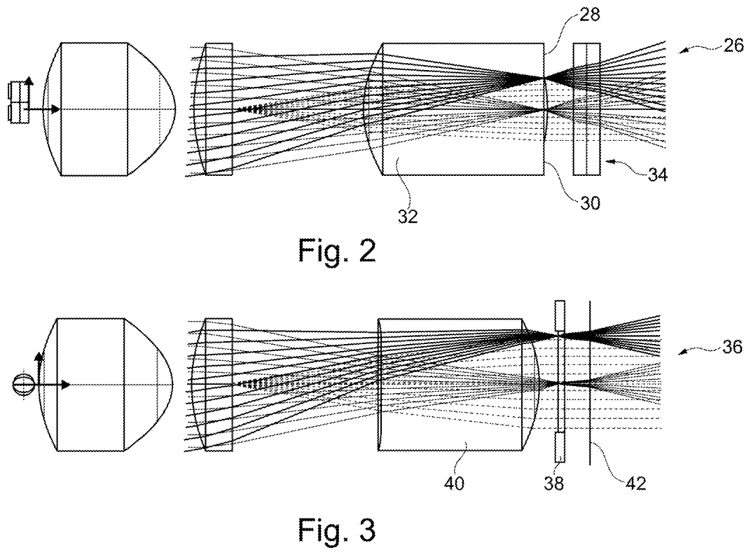

According to FIG. 2, a further embodiment of a projector assembly 26 is shown. In this case, an aperture diaphragm 28 is likewise formed on a light exit surface 30 of a projection lens 32. In general, the position of the aperture diaphragm defines the length of the projector assembly. For this reason, in particular in contrast to “Köhler Illumination”, the aperture diaphragm 28 according to the embodiment in FIG. 2 is arranged on or in the last surface of the projection lens 32. After the projection lens 32, a disk 34 or a window is provided according to FIG. 2, which has two disk sections of equal thickness.

FIG. 3 shows a further embodiment of a projector assembly 36. In contrast to FIG. 2, this has an aperture diaphragm 38, which is not arranged on a projection lens 40, but is subsequently provided. The aperture diaphragm 38 is thus connected downstream of the projection lens 40 and is arranged behind the projection lens 40. For example, it is conceivable to arrange the aperture diaphragm 38 on a disk 42 or a window, which is schematically indicated in FIG. 3.

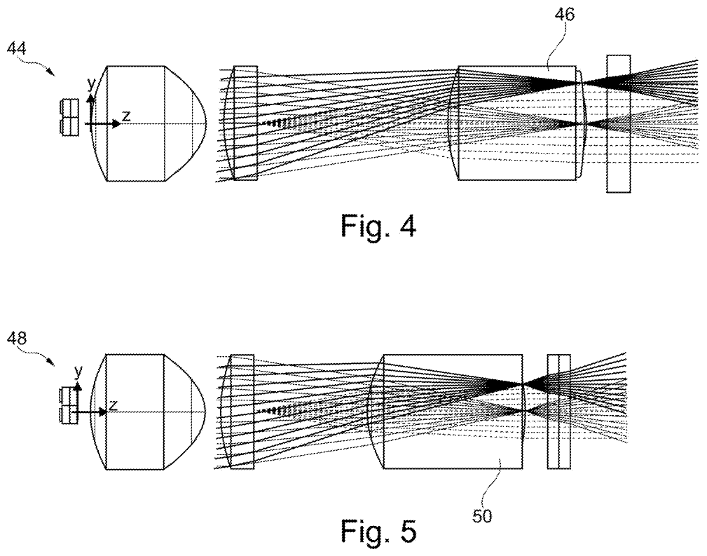

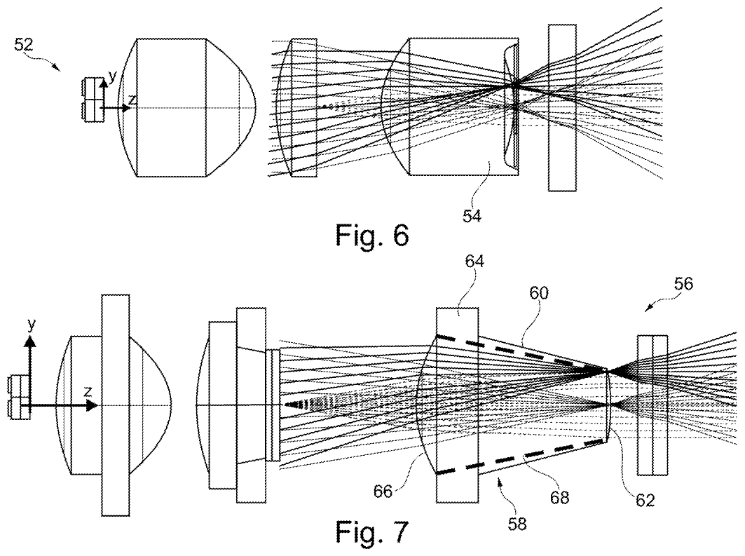

According to FIG. 4, a further projector assembly 44 is shown. This has a projection lens 46 with a focal length of 10.03 mm. This results in an image size of 500 mm at a distance of 1 m in the far field. FIG. 5 shows a projector assembly 48 with a projection lens 50, which has a focal length of 6.25 mm. This results in an image size of 800 mm in the far field at a distance of 1 m. FIG. 6 represents a projector assembly 52, which has a projection lens 54 with a focal length of 4 mm. This results in an image size of 1,250 mm at a distance of 1 m in the far field. In the embodiments shown in FIGS. 4 to 6, the same collimation lenses and the same gobo lenses are used. The gobo provided in the gobo lens has a size, in particular a diameter, of 5 mm. In the embodiments, the focal length along with the size of the gobo defines the image size of the image from the gobo displayed in the far field. Further values for the focal length of a projection lens and the resulting image can be found in the following table:

| Focal length | Field angle in | Image size | Lighting |
|---|---|---|---|
| in mm | the image space | in mm @1 m | intensity in 1x |
| 14.18 | 10.0 | 350 | x |
| 10.03 | 14.0 | 500 | 0.51*x |
| 8.18 | 17.0 | 610 | 0.35*x |
| 6.87 | 20.0 | 730 | 0.25*x |
| 5.36 | 25.0 | 930 | 0.16*x |
| 4.00 | 32.0 | 1,250 | 0.10*x |

FIG. 7 shows a further projector assembly 56. This has a projection lens 58, which has a frustoconical lens portion 60. The lens portion 60-5 extends from a light exit surface 62 counter to the radiation direction, wherein the latter widens. The lens portion 60 ends in a radial collar 64 of the projection lens 58. A light entry surface 66 of the projection lens 58 adjoins the radial collar 64 on its side facing away from the lens portion 60. The radial collar 64 is circular cylindrical and has a larger diameter compared to the light entry surface 66 and in compared to the frustoconical lens portion 60. An aperture diaphragm is formed by the frustoconical lens portion 60. A minimum possible outer contour of the projection lens 58, in which it can form the aperture diaphragm with a frustoconical section, is shown with a dashed line 68. The radial collar 64 is used to fasten the projection lens 58 in a housing, which is explained in more detail below.

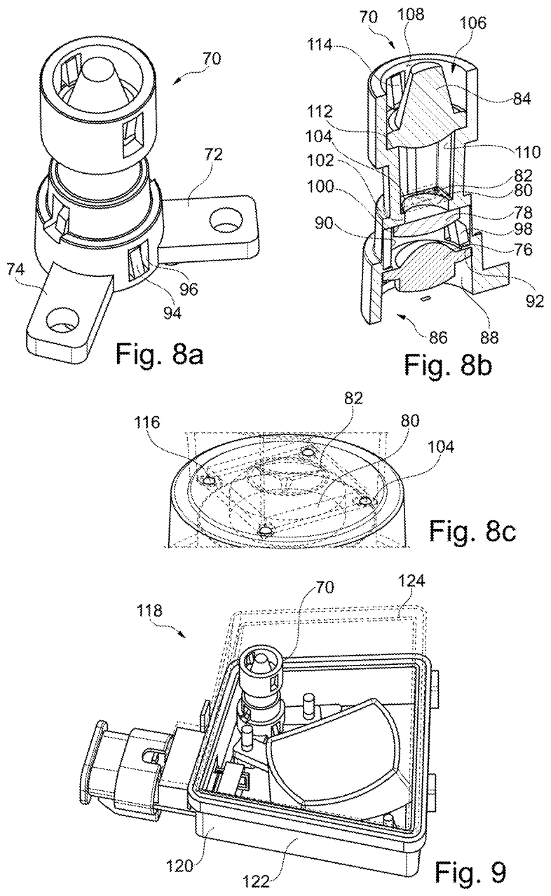

FIG. 8 a shows a housing 70 for a projector assembly. This is tubular and has two radially extending feet 72, 74 on the longitudinal side in order to attach the housing 70.

FIG. 8b shows a longitudinal section through the housing 70. A collimation lens 76, a gobo lens 78, a carrier 80 with a gobo 82 and a projection lens 84 are arranged in the housing 70. The housing 70 has a first inner step 86. This has a first inner stepped lateral surface 88 and a second inner stepped lateral surface 90, which has a smaller diameter. The stepped lateral surfaces 88, 90 are each configured to be frustoconical and taper in the direction of radiation. A stepped surface 92, which points counter to the radiation direction, is formed between the stepped lateral surfaces 88, 90. This serves as a contact surface for a radial collar of the collimation lens 76. The first inner stepped lateral surface 88 also serves as a housing opening, wherein the largest diameter defines the opening size. A housing spring 94 is formed in the first inner stepped lateral surface 88 according to FIG. 8a. This extends from a spring space 96, which is introduced radially continuously into the housing 70. The housing spring 94 projects into the lens space delimited by the first inner stepped lateral surface 88 and engages on the radial collar of the collimation lens 76 and presses it against the stepped surface 92. During assembly, in the case of an axial insertion of the projection lens 84 into the first inner stepped lateral surface 88, the housing spring 94 is tensioned radially outwards into the spring space 96 by the projection lens 84. After a specific insertion depth of the projection lens 84, the force application of the housing spring 94 ends via the collimation lens 76, whereby the housing spring 94 at least partially expands and moves back into the lens space. In this case, it overlaps the radial collar of the collimation lens 76 and presses this against the stepped surface 92, whereby the projection lens 84 is fixed. Preferably, two housing springs 94 are provided with a corresponding spring space in the first inner stepped lateral surface 88 on a pitch circle.

According to FIG. 8b, housing springs 98 are also formed in the second inner stepped lateral surface 90. These correspond to the housing spring 94. With the housing springs 98, the gobo lens 78 is tensioned against an end face 100 of an inner radial collar 102 of the housing 70. In this case, the end face 100 is counter to the radiation direction. The mounting of the gobo lens 78 corresponds to the assembly of the collimation lens 76, wherein the gobo lens 78 is mounted in front of the collimation lens 76 and is inserted into the second inner stepped lateral surface 90 via the first inner stepped lateral surface 88. The inner radial collar 102 preferably has a circular cylindrical inner lateral surface. In addition to the end face 100, it has a further end face 104 pointing in the radiation direction, which serves as a gobo contact surface. The end face 104 serves to fasten the carrier 80 to the gobo 82, which is explained in more detail below with reference to FIG. 8c. In the direction of radiation, as seen downstream of the radial collar 102, a further second step 106 is formed in the housing 70. This has a first inner stepped lateral surface 108, which forms a housing outlet opening. In addition, the second step 106 has a second inner stepped lateral surface 110. A stepped surface 112, which points in the radiation direction, is formed between the stepped lateral surfaces 108, 110. The stepped surface 112 serves as a contact for the projection lens 84, which rests against it with a radial collar. The projection lens 84 is inserted into the housing 70 via the first inner stepped lateral surface 108. Furthermore, the projection lens 84 is tensioned against the stepped surface 112 by housing springs 114. These are designed in accordance with the housing spring 94, but are oriented differently. As a result, during the mounting of the projection lens 84 counter to the direction of radiation into the first inner stepped lateral surface 108, the housing spring 114 is initially tensioned radially and extends over the projection lens 84. The carrier 80 is arranged in the second inner stepped lateral surface, which is explained in more detail with reference to FIG. 8c.

According to FIG. 8c, it can be seen that the carrier 80 is designed as a, in particular rectangular, disk. On its side pointing in the radiation direction, the gobo 82 is applied as a film. On its side facing the direction of radiation, the carrier 80 is glued to the end face 104 via four adhesive regions 116, of which only one is provided with a reference sign for the sake of simplicity. The adhesive regions 116 each have a UV-curable adhesive. The carrier 80 is placed on the end face 104 before the projection lens 84 is assembled, wherein the adhesive is arranged between the carrier 80 and the end face 104 in the case of the four adhesive regions 116, which are provided on the corner side of the carrier 80. Between an outer lateral surface of the carrier 80 in the second inner stepped lateral surface 110 (see FIG. 8b), there is a tolerance distance, whereby the carrier 80 is displaceable relative to the end face 104 transversely to the main emission axis in a displaceable manner. After precise positioning of the carrier 80, the adhesive from the adhesive regions 116 is cured. As a result, the carrier 80 is fixedly connected to the housing 70 (see FIG. 8 a). After the carrier 80 is mounted, the projection lens 84 can be used.

FIG. 9 shows a projection system 118. This has a system housing 120. This has a socket-shaped housing part 122. The housing 70 for the projector assembly is accommodated and fastened in this housing part. Furthermore, additional components that can be provided for a projector are arranged therein. The housing part 122 is closed by a further housing part 124, which is transparent, or at least partially transparent, and can form a window.

A projector assembly with at least one light source, which is connected downstream of a gobo screen, is disclosed. The gobo screen has a gobo aperture diaphragm and a gobo lens. A projection lens is connected downstream of the gobo screen. In addition, an aperture diaphragm is connected downstream of the gobo screen. The light emitted by the light source is focused in the aperture diaphragm via the gobo lens. The image from the gobo screen is displayed in the far field via the projection lens.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

LIST OF REFERENCE SIGNS

| | |
|---|---|
| Projector assembly | 1, 26, 36, 44, 48, 52, 56 |
| LED | 2 |
| Collimation lens | 4, 76 |
| Gobo lens | 6, 78 |
| Gobo aperture diaphragm | 8 |
| Light entry surface | 10, 66 |
| Light exit surface | 12, 30, 62 |
| Projection lens | 14, 32, 40, 46, 50, 54, 58, 84 |
| Aperture diaphragm | 16, 28, 38 |
| Beam | 18, 20, 24 |
| Gobo | 22, 82 |
| Disk | 34, 42 |
| Lens portion | 60 |
| Radial collar | 64 |
| Dashed line | 68 |
| Housing | 72, 74 |
| Carrier | 80 |
| First step | 86 |
| First inner stepped lateral surface | 88, 108 |
| Second inner stepped lateral surface | 90, 110 |
| Stepped surface | 92, 112 |
| Housing spring | 94, 98, 114 |
| Spring space | 96 |
| End face | 100, 104 |
| Second step | 106 |
| Adhesive region | 116 |
| Projection system | 118 |
| System housing | 120 |
| Housing part | 122, 124 |

What is claimed is:

1. A projector assembly with at least one light source, with a gobo screen which is connected downstream of the light source and upstream or downstream of which a gobo aperture diaphragm is connected or which has a gobo aperture diaphragm, with a gobo lens, which is connected downstream of the light source and is connected upstream or downstream of the gobo screen, with a projection lens, which is connected downstream of the gobo screen, and with an aperture diaphragm, which is connected downstream of the gobo screen, the gobo lens being designed and arranged in such a way that the light emitted by the light source is focused into an image plane of the aperture diaphragm, and wherein the projection lens is designed and arranged in such a way that it displays an image plane from the gobo screen in a far field.

2. The projector assembly according to claim 1, wherein a collimation lens is provided downstream of the light source and is connected upstream of the projection lens and the gobo screen and the gobo aperture diaphragm.

3. The projector assembly according to claim 1, wherein the gobo screen has a carrier with a light entry surface and a light exit surface, and wherein a gobo is formed on at least one of the light entry surface and the light exit surface, wherein the gobo is formed as a film.

4. The projector assembly according to claim 1, wherein a carrier is formed separately or wherein the gobo lens is provided as a carrier.

5. The projector assembly according to claim 1, wherein the aperture diaphragm downstream of the gobo screen is arranged downstream of the projection lens.

6. The projector assembly according to claim 5, wherein the aperture diaphragm downstream of the gobo screen is formed on a light exit surface of the projection lens, or wherein the aperture diaphragm downstream of the gobo screen is spaced apart from the projection lens, or wherein the projection lens, starting from the light exit surface, has a frustoconical lateral surface, which widens in a direction towards the light source, wherein the aperture diaphragm is formed by the light exit surface.

7. The projector assembly according to claim 1, wherein a housing is provided in which at least one of a collimation lens, the projection lens, a carrier, and the gobo lens are arranged and fixed, wherein the housing has a gobo contact surface, which surrounds a beam path of the light at least in portions or completely, wherein one or more adhesive regions are provided between the carrier and the gobo contact surface in order to bond them to one another, wherein an adhesive from the one or more adhesive regions is UV-curable.

8. The projector assembly according to claim 1, wherein a housing has at least one of a first inner step having a first stepped surface pointing counter to a direction of radiation, on which a collimation lens is axially supported and a second inner step having a second stepped surface pointing in the direction of radiation, on which the projection lens is axially supported.

9. The projector assembly according to claim 8, wherein at least one housing spring is provided for at least one of fixing the projection lens and fixing the collimation lens.

10. A projection system with a system housing in which the projector assembly according to claim 1 is arranged, wherein further projector components are arranged in the system housing.
